(19) United States
(12) Patent Application Publication
(10) Pub. No.: US 2013/0276606 A1
(43) Pub. Date: Oct. 24, 2013

(54) CUTTING TOOL HEAD FOR MULTI-PLY FABRIC CUTTING MACHINE

(71) Applicant: EASTMAN MACHINE COMPANY, Buffalo, NY (US)

(72) Inventor: Krzysztof BIERNAT, Lancaster, NY (US)

(73) Assignee: EASTMAN MACHINE COMPANY, Buffalo, NY (US)

(21) Appl. No.: 13/829,458

(22) Filed: Mar. 14, 2013

Related U.S. Application Data
(60) Provisional application No. 61/637,442, filed on Apr. 24, 2012.

(51) Int. Cl. B26D 5/08; B26D 7/12

(52) U.S. Cl. CPC B26D 5/08; B26D 7/12
USPC 83/174; 83/628

(57) ABSTRACT

A cutting tool head for a sheet material cutting machine has a pressure foot mounted by way of linear actuators operable to independently move the pressure foot vertically relative to an eccentric drive mechanism and a knife assembly of the tool head. The knife assembly includes a support shaft driven by the eccentric mechanism, a blade connected to the support shaft, and a splined shaft between the support shaft and blade The splined shaft slides in a splined bushing, and the eccentric mechanism drives reciprocating motion of the support shaft, the splined shaft, and the blade relative to the splined bushing. The splined bushing is rotatable to rotate the splined shaft and blade. A blade sharpener of the tool head has a sharpening disc backed by a magnetic disc to attract the blade into evenly distributed contact with the sharpening surface, and to retain metal shavings on the sharpening disc.

### CROSS-REFERENCE TO RELATED APPLICATIONS

The present application claims priority of U.S. Provisional Patent Application No. 61/637,442 filed Apr. 24, 2012, the entire contents of which are incorporated herein by reference.

### FIELD OF THE INVENTION

The present invention relates to the field of machine tools for cutting fabric and other sheet materials, and more particularly to cutting tool heads for such machines.

### BACKGROUND OF THE INVENTION

Cutting tool heads according to known designs have an eccentric mechanism that drives reciprocating up-and-down motion of a knife assembly to perform cutting operations. The knife assembly typically includes a support shaft connected to the eccentric mechanism and a vertical blade connected to the support shaft. Known cutting tool heads also have a pressure foot for contacting the material being cut, wherein the blade extends through a knife opening in the pressure foot to engage the material. In designs of the prior art, the eccentric mechanism, knife assembly, and pressure foot are mounted on a support frame that is vertically movable relative to a main support carriage of the tool head by operation of an actuator. The pressure foot is mounted on the vertically movable support frame by spring-biased support rods such that the pressure foot is able to deflect vertically relative to the eccentric mechanism and knife assembly. To engage the pressure foot with the material, the entire support frame is lowered. Conversely, to disengage the pressure foot from the material, for example where the cutting tool head is commanded to travel to a different cutting location on the material, the entire support frame must be moved upward by a distance sufficient to bring the pressure foot out of contact with the material. Because the pressure foot is spring-biased toward a downward position, the vertical movement distance of the support frame needed to achieve clearance from the material must take into account the spring deflection and thus may be greater than a simple upward incremental movement away from the material. This arrangement is not optimal in terms of cut-time efficiency and power consumption. An example of a prior art cutting tool head in accordance with the forgoing description is found in U.S. Pat. No. 4,841,822.

In cutting tool heads, it is desirable that the knife assembly be configured to allow the blade to rotate about its vertical axis relative to the support shaft coupled to the eccentric drive mechanism. For this purpose, it is known to fasten the blade to the lower end of a vertical hollow cylinder, and to insert a spherical bushing into the upper end of the cylinder, wherein the spherical bushing is connected to the eccentric mechanism via a flexible link. The cylinder is slidably received within a vertical guide sleeve having an internal grove that engages a protruding edge of a tang at the trailing end of the blade. The guide sleeve is supported in the cutting tool head by rotary bearings and a rotary drive is coupled to the guide sleeve. When the guide sleeve is rotated, its rotation is transmitted to the blade and the cylinder, which rotate relative to the spherical bearing. The rotary drive and guide sleeve are mounted on a fixed support plate of the cutting tool head, and the eccentric mechanism and knife assembly are mounted for vertical movement relative to the support plate. U.S. Pat. No. 3,955,458 illustrates this type of configuration. As may be understood, maintenance and repair are time consuming. The spherical bearing, which is subject to wear from operating cycles, is difficult to replace because it is within the cylinder. Lubrication of the cylinder for sliding within the guide sleeve is difficult because there is a lack of easy access. Moreover, changing the knife blade requires removal of the blade from within the lubricated interior of the guide sleeve, making the task messy and time consuming.

Cutting tool heads that incorporate an abrasive blade sharpening element are also known. A drawback of known designs is that the blade, which is subject to deflection, does not have a uniform force distribution over its contact area with the abrasive surface, resulting in uneven sharpening and diminished cut quality. Another drawback is that the metal shavings from the blade are not contained and can become lodged in the cutting tool head.

### SUMMARY OF THE INVENTION

The present invention addresses the problems mentioned above while providing a compact, reliable tool head that is easy to maintain.

In accordance with a first aspect of the present invention, an eccentric mechanism, a knife assembly, and a pressure foot are mounted on a support assembly by a slide plate for vertical movement as a unit relative to the support assembly, and the pressure foot is mounted on the slide plate by way of at least one linear actuator operable to move the pressure foot up and down independently relative to the eccentric mechanism and the knife assembly.

In another aspect, the present invention provides an improved configuration for vertically guiding the knife assembly and rotating the knife blade. The knife assembly includes a support shaft drivably connected to the eccentric mechanism, a vertical blade connected to the support shaft, and a vertical splined shaft arranged between the support shaft and the vertical blade The splined shaft is slidably received by a splined bushing, and the eccentric mechanism drives reciprocating up-and-down motion of the support shaft, the splined shaft, and the blade relative to the splined bushing. The eccentric mechanism, the knife assembly, and the splined bushing are mounted on the support assembly for vertical movement as a unit relative to the support assembly, and the splined bushing is rotatable about a vertical axis relative to the support shaft to impart rotation to the splined shaft and the blade relative to the support shaft.

In a further aspect, the invention provides a cutting tool head having improved means for sharpening a blade. The blade sharpening means includes at least one blade sharpening disc having a sharpening surface coated with abrasive material for contacting the blade and a magnetic backing disc behind the sharpening surface for magnetically attracting the blade to urge the blade into evenly distributed contact with the sharpening surface.

### BRIEF DESCRIPTION OF THE DRAWING VIEWS

The invention is described in detail below with reference to the following figures:

FIG. 1 is a perspective view showing an automated multi-ply cutting machine incorporating a cutting tool head in accordance with an embodiment of the present invention;

FIG. 2 is a perspective view of the cutting tool head, wherein an external housing of the tool head is rendered transparent to reveal internal structure;

FIG. 3 is a right side view of the cutting tool head without the housing;

FIG. 4 is a left side view of the cutting tool head without the housing;

FIG. 5 is a rear view of the cutting tool head without the housing;

FIG. 6 is a top view of the cutting tool head without the housing;

FIG. 7 is a front view of the cutting tool head without the housing, wherein a pressure foot assembly of the tool head is shown in an extended condition and a knife assembly of the tool head is shown in a raised home position;

FIG. 8 is a view similar to that of FIG. 7, wherein the pressure foot assembly is shown in a compressed condition and the knife assembly is shown in a lowered cutting position;

FIG. 9 is a view similar to that of FIG. 7, wherein a sharpening assembly is shown in sharpening engagement with a cutting blade mounted in the tool head;

FIG. 10 is an enlarged perspective view of the sharpening assembly in sharpening engagement with a cutting blade mounted in the tool head;

FIG. 11 is another enlarged perspective view of the sharpening assembly in sharpening engagement with a cutting blade mounted in the tool head;

FIG. 12 is a perspective view of the sharpening assembly in isolation, wherein an outer housing of an indexing gear box of the sharpening assembly is rendered transparent to reveal internal structure;

FIG. 13 is an enlarged perspective view showing a pair of sharpening wheels, an indexing gear box, and a rotary actuator of the sharpening assembly in isolation, wherein the outer housing of the indexing gear box is rendered transparent to reveal internal structure;

FIG. 14 is a sectional view of the tool head showing the knife assembly;

FIG. 15 is a perspective view of the knife assembly in isolation;

FIG. 16 is a sectional view of the knife assembly in isolation; and

FIG. 17 is an enlarged perspective view showing a coupling for removably mounting a cutting blade on the knife assembly.

### DETAILED DESCRIPTION OF THE INVENTION

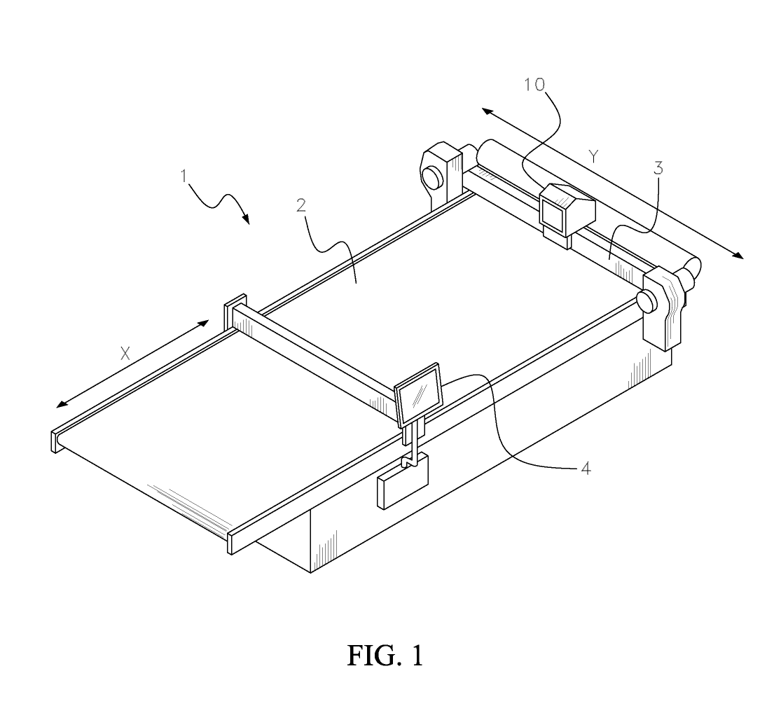

FIG. 1 shows an automated multi-ply cutting machine 1 for cutting fabric and other sheet materials. Cutting machine 1 includes a cutting table 2 straddled by a gantry 3 movable along the cutting table 2 in an X direction. The gantry 3 extends in a lateral Y direction of table 2 perpendicular to the X direction. A cutting head 10 formed in accordance with an embodiment of the present invention is mounted on gantry 3 for travel with the gantry, and is movable along the gantry laterally relative to table 2 in the Y-direction. Cutting head 10 is configured to hold tools, for example a cutting knife, a drill, and/or a marking pen, and to operatively engage the tools with fabric or sheet material present on table 2. A computer with an operator workstation 4 is provided to enable cutting machine 1 to be programmed to cut or mark shapes and patterns from or on the fabric or sheet material. Software executed by computer 4 provides an operator interface to program and store jobs, and to run jobs by converting stored job parameters into motion commands controlling the X axis position of gantry 3, the Y axis position of tool head 10, the vertical Z axis position of a tool carried by tool head 10, and tool reciprocating or rotary motion.

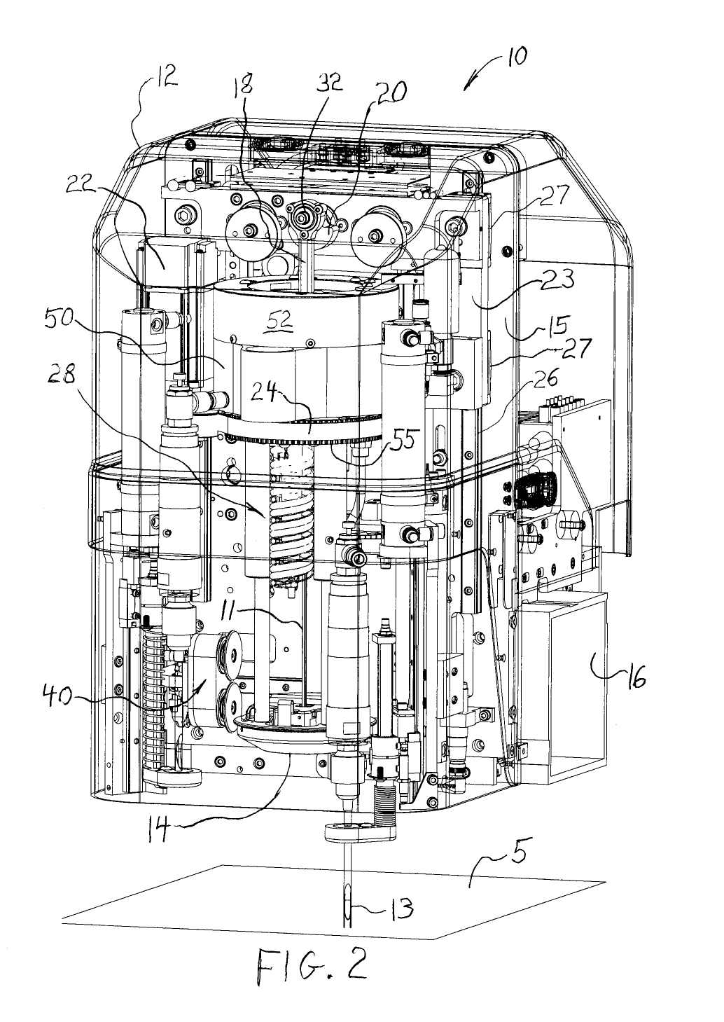

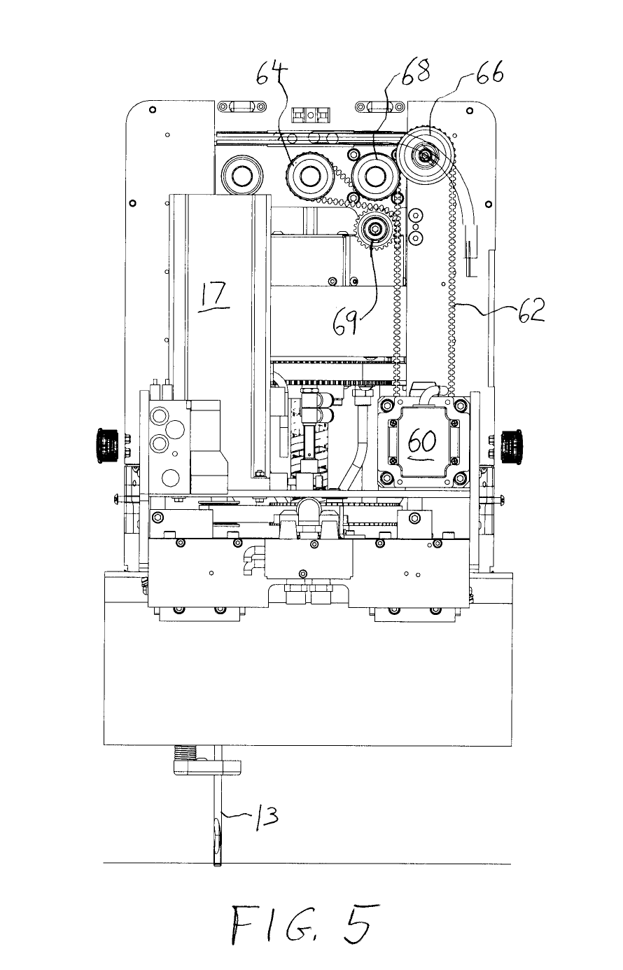

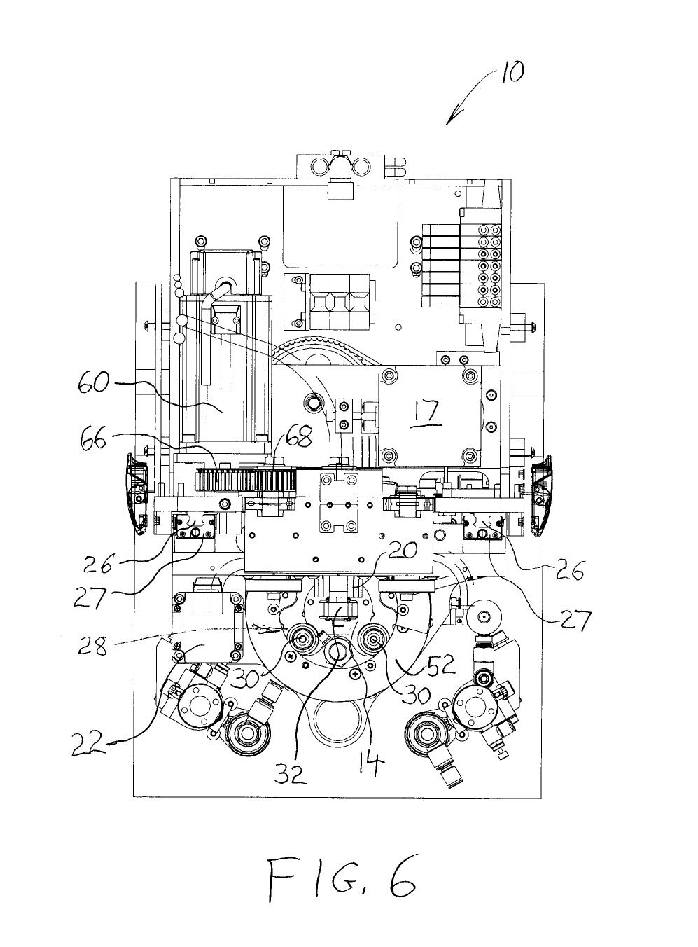

Tool head 10 of the present invention is shown in FIGS. 2-7. Tool head 10 comprises an external housing 12 enclosing a support assembly 15 and gantry sleeve 16. Gantry sleeve 16 receives gantry 3, and a drive motor 17 mounted on support assembly 15 is connected to the gantry and is operable to displace tool head 10 along the gantry. A drill 13 is operable to protrude downwardly from housing 12 to engage material 5.

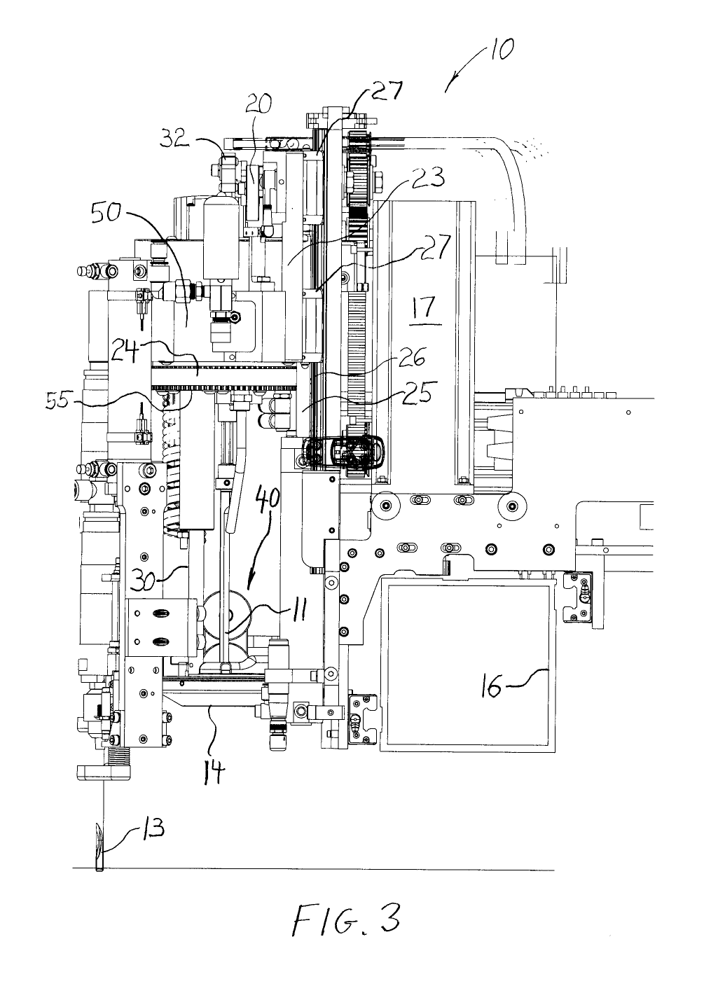

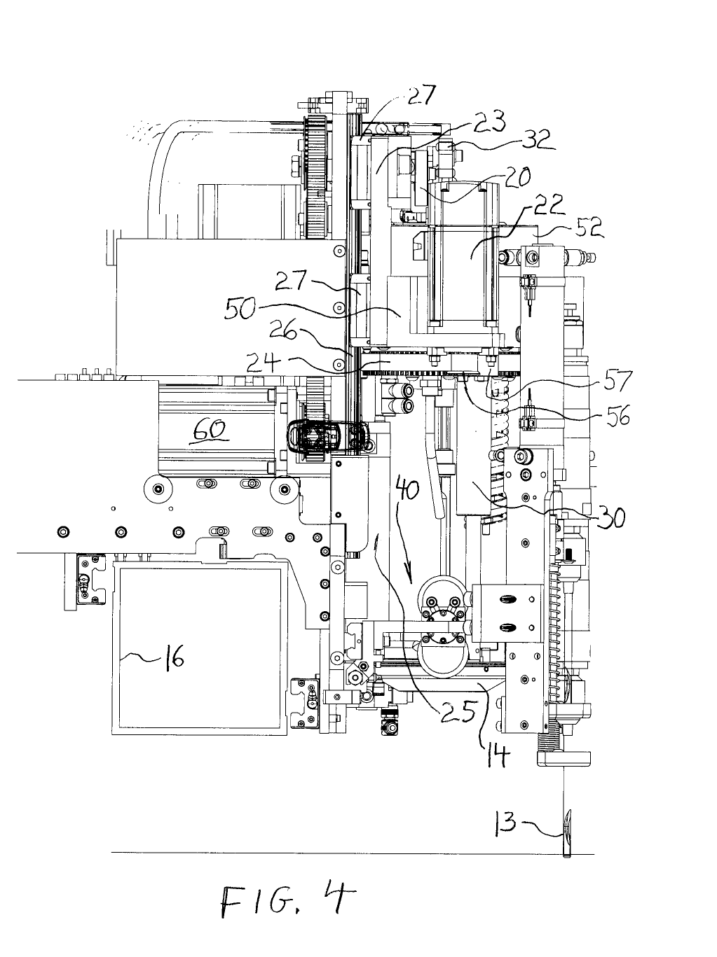

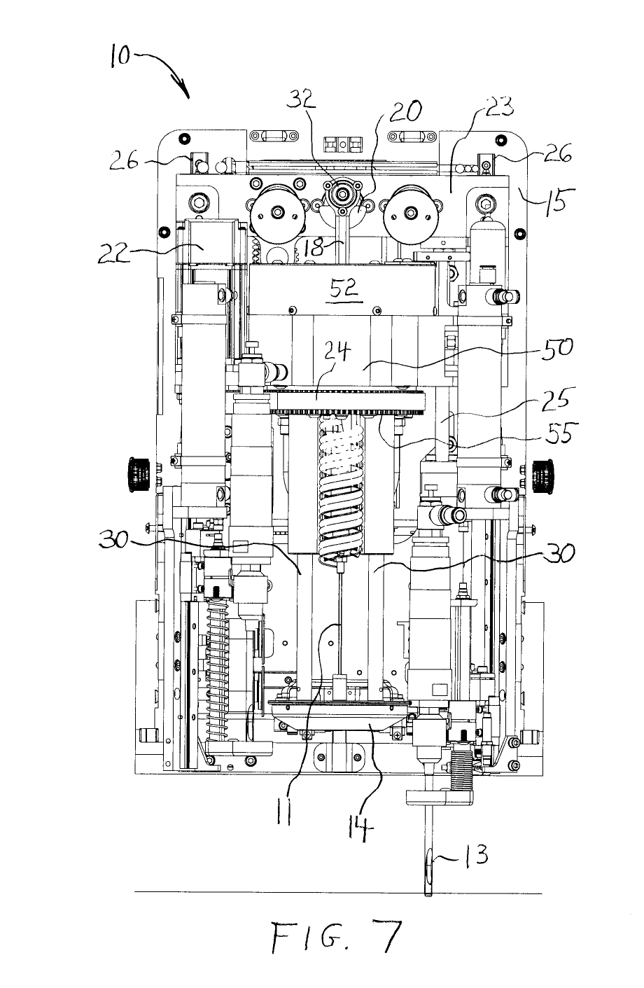

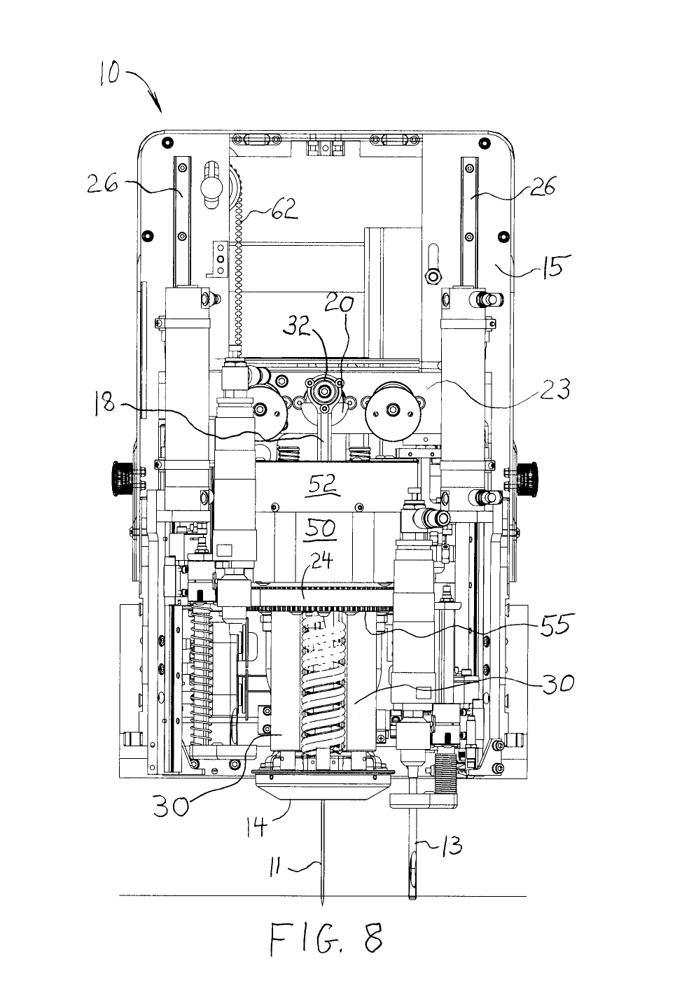

A cutting blade 11 extends vertically and is receivable through an opening in a pressure foot 14. The cutting blade is part of a knife assembly that extends vertically through tool head 10. The knife assembly includes a support shaft 18 near its upper end. Support shaft 18 is coupled by a rotary bearing 32 to an eccentric mechanism 20, whereby rotational motion inputted to the eccentric mechanism results in a reciprocating up-and-down motion of the support shaft 18 and blade 11. Eccentric mechanism 20 and the reciprocating knife assembly are carried by a slide plate 23 mounted for vertical travel relative to support assembly 15 by linear slide bearings 27 movable along vertical rails 26 fixed to support assembly 15. Slide plate 23 is moved up and down by a linear actuator 25 visible in FIGS. 3 and 4. Slide plate 23 and linear actuator 25 are operable to move the knife assembly between a raised home position as depicted in FIG. 7 and a lowered cutting position as depicted in FIG. 8. Linear actuator 25 may be pneumatically or electro-mechanically driven.

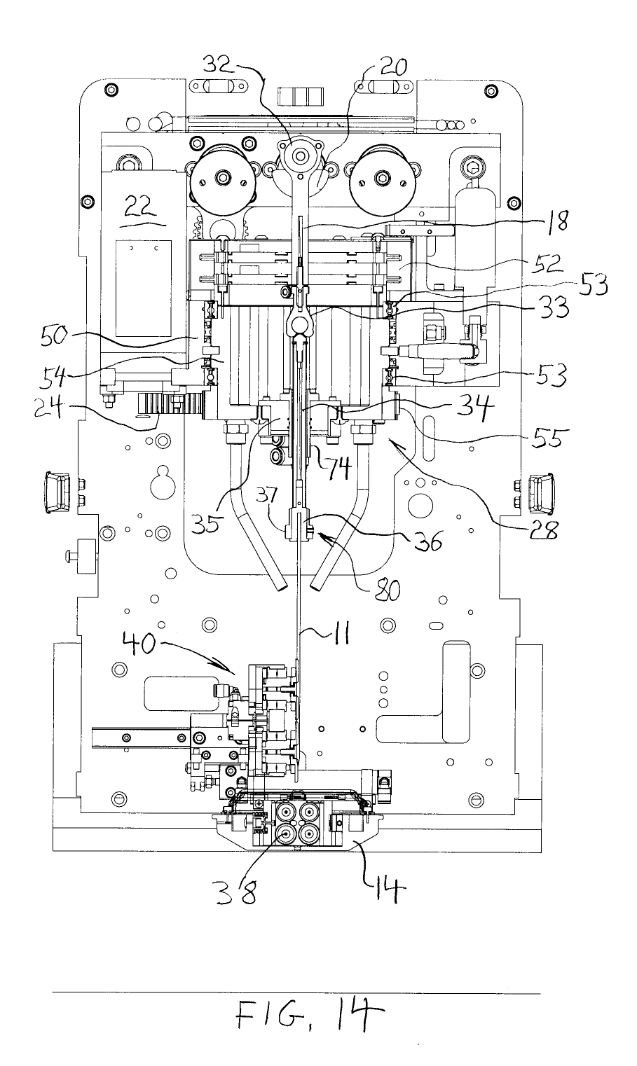

Additional reference is made now to the sectional view of FIG. 14. The knife assembly extends through a pressure foot assembly generally indicated by reference numeral 28. Pressure foot assembly 28 is rotatable about a vertical axis that coincides substantially with a line of action of the knife assembly. As will be described in greater detail below, the pressure foot assembly transmits its rotation to blade 11. Pressure foot assembly 28 is mounted on slide plate 23 by a yoke 50. Pressure foot assembly 28 includes pressure foot 14, a pair of linear actuators 30, a rotation sprocket 55, a support cylinder 54 coupled to rotation sprocket 55 and rotatably mounted in yoke 50 by rotary bearings 53, and a slip ring assembly 52. A drive motor 22 mounted on yoke 50 is operable to rotate sprocket 55 and support cylinder 54 via a drive belt 24 engaged by a drive sprocket 56 on the output shaft of motor 22 and by an idler roller 57. An upper portion of each linear actuator 30 is coupled to support cylinder 54 and a lower portion of each linear actuator 30 is coupled to pressure foot 14, whereby rotation of sprocket 55 and support cylinder 54 is transmitted to pressure foot 14. Linear actuators 30 are operable to move pressure foot 14 up and down relative to the knife assembly as can be seen by comparing FIGS. 7 and 8.

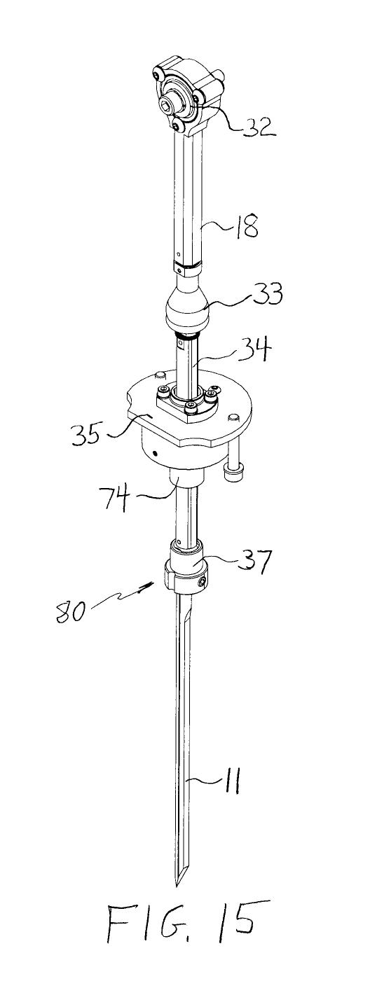

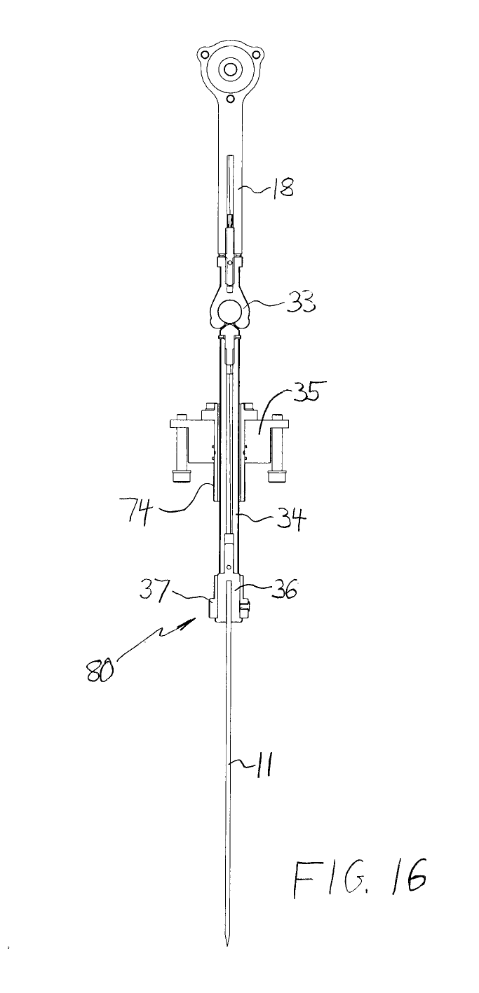

The reciprocating knife assembly of the present invention will now be described in greater detail with reference to FIGS. 14-17. As mentioned above, the knife assembly has a rotary bearing 32 and a support shaft 18 that extends downwardly from rotary bearing 32. A splined shaft 34 is connected to a lower end of support shaft 18 by a ball joint 33. Splined shaft 34 is slidably received through a splined bushing 74 which is coupled to support cylinder 54 by a hub member 35. As will be understood, the slidably mating splines of shaft 34 and bushing 74 permit the knife assembly to reciprocate vertically while also transmitting rotational motion of support cylinder 54 to the portion of the knife assembly below ball joint 33.

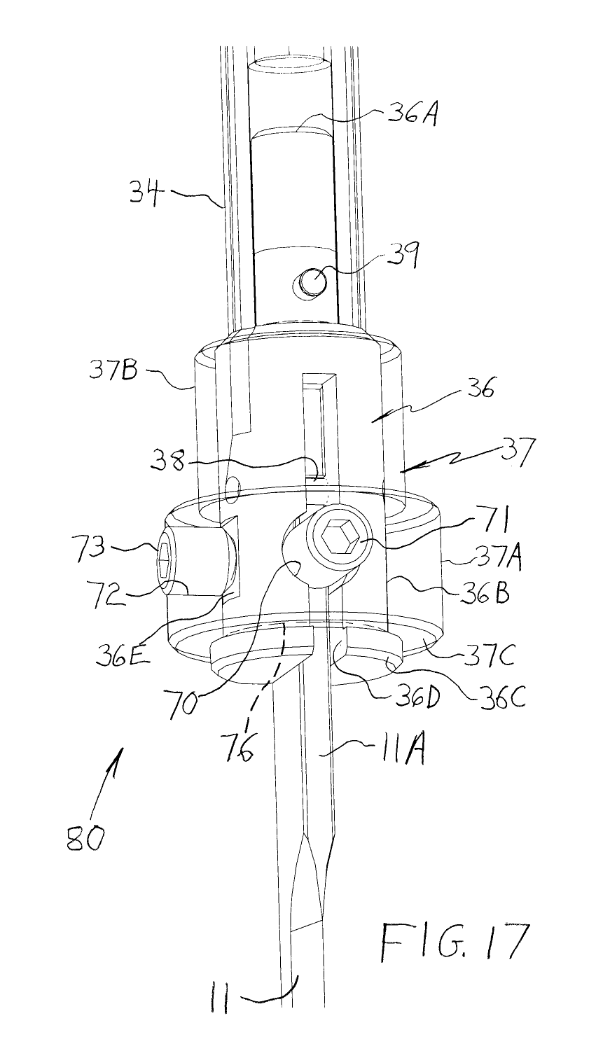

Blade 11 is removably mounted on the knife assembly by a collar assembly 80 located at a lower end of splined shaft 34. Collar assembly 80 includes an inner clamp member 36 surrounded by an outer securement collar 37. Clamp member 36 includes a stem portion 36A extending upwardly into an axial opening at the lower end of splined shaft 34 and held in place by a transverse pin 39 arranged to extend through aligned openings in the shaft 34 and stem portion 36A. Clamp member 36 further includes a main portion 36B, a bottom flange 36C, and a diametrical slot 36D extending upwardly through bottom flange 36C and partially through main portion 36B. Slot 36D is sized and configured to receive a shank portion 11A of blade 11. Shank portion 11A may be retained in slot by a transverse pin 38 extending through aligned holes in main portion 36B and shank portion 11A. Main portion 36B is generally cylindrical but has a flat side (not visible in FIG. 17) to form a D-shaped profile. Securement collar 37 includes a corresponding D-shaped opening for 76 receiving main portion 36B of clamp member 36. Securement collar 37 has a radially enlarged portion 37A, a radially reduced portion 37B, and a bottom surface 37C arranged to engage bottom flange 36C of the clamp member. Securement collar 37 surrounds main portion 36B, thereby preventing removal of pin 38. Securement collar 37 has a first threaded hole 70 extending radially through enlarged portion 37A for threadably receiving a first set screw 71 adjustable to press shank portion 11A against a flat inner surface of D-shaped opening 76. Securement collar 37 has a second threaded hole 72 extending radially through enlarged portion 37A but offset angularly from first threaded hole 70 by ninety degrees for threadably receiving a second set screw 73 adjustable to engage main portion 36B of clamp member 36. Thus, second set screw 73 has a line of action transverse to slot 36D, such that opposing prongs of main portion 36B bifurcated by slot 36D are forced toward an inner surface of D-shaped opening 76. Tightening of set screws 71 and 73 eliminates play between blade 11 and the collar assembly 80 to securely attach blade 11 to the knife assembly. A flatted surface 36E may be provided on clamp member 36 for engagement by second set crew 73.

As will be appreciated, the arrangement described above permits easy and safe replacement of worn blades. To replace blade 11, set screws 71 and 73 are loosened and securement collar 37 is slid upward beyond pin 38 (one or both set screws may be adjusted to engage splined shaft 34 to temporarily maintain collar 37 above pin 38). Pin 38 is then displaced until it no longer retains shank 11A, at which point blade 11 is removed from collar assembly 80. The shank of a new blade may then be inserted into slot 36D, collar 37 lowered to surround clamping member 36, and set screws 71 and 73 tightened. Changeover to a new blade can be accomplished in about one minute, thus reducing job down time. The changeover location is spaced from lubricated bearings associated with reciprocating sliding motion of the knife assembly, thereby making changeover a much cleaner operation relative to prior art tool heads that required removal of the greased slide mechanism to change blades.

Since the knife assembly may be driven at about 4,000 rpm, wear on the components is a concern. The knife assembly of the present invention is lightweight, thereby reducing stress. Most of the wear occurs at ball joint 33, which experiences accelerations of about 300 G-forces during reciprocating motion. Ball joint 33 may be an inexpensive off-the-shelf part, such as Part No. RBI 6D from THK Co., Ltd., allowing economical stocking of spare parts and immediate replacement to avoid machine down time.

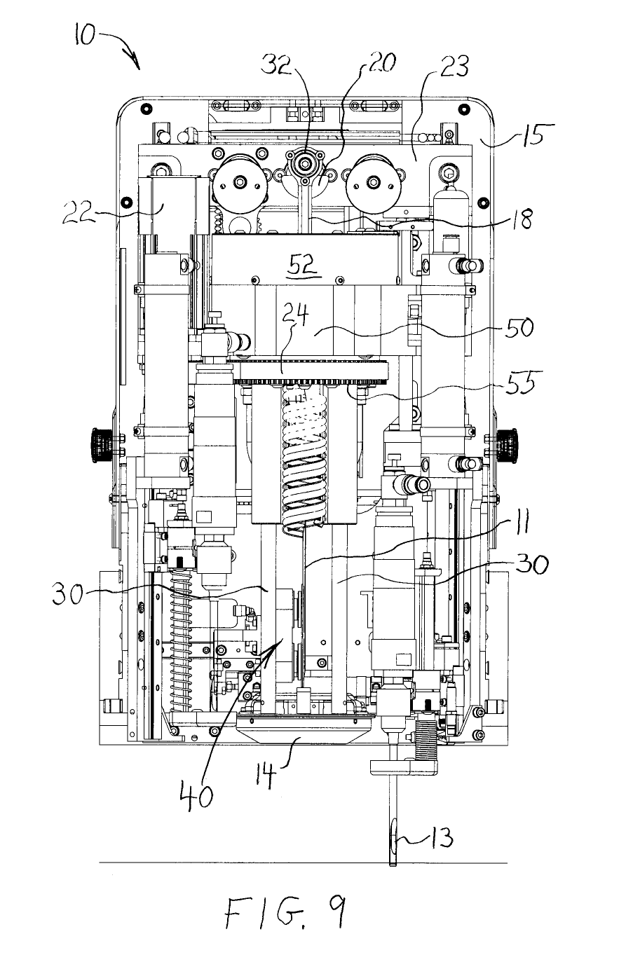

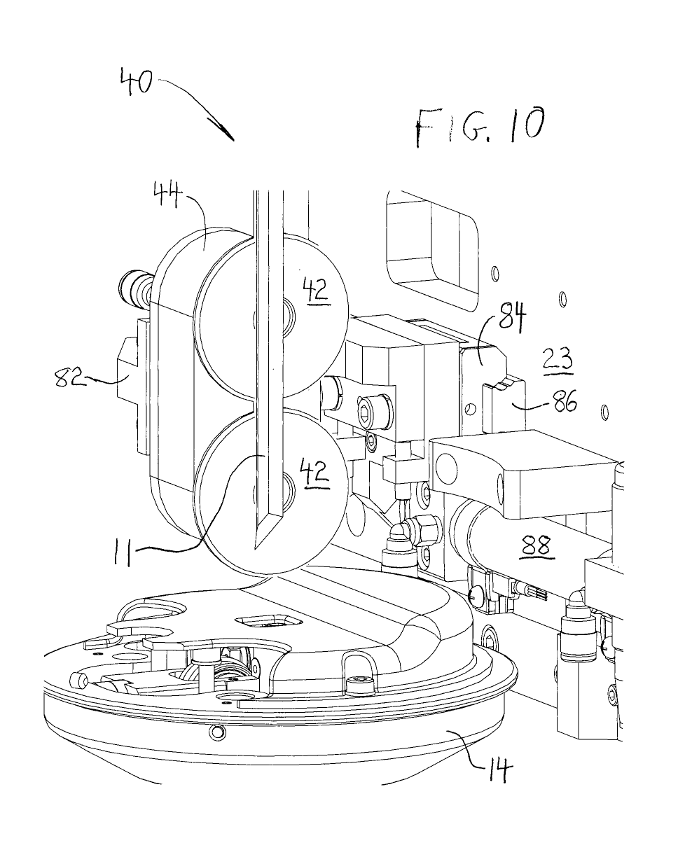

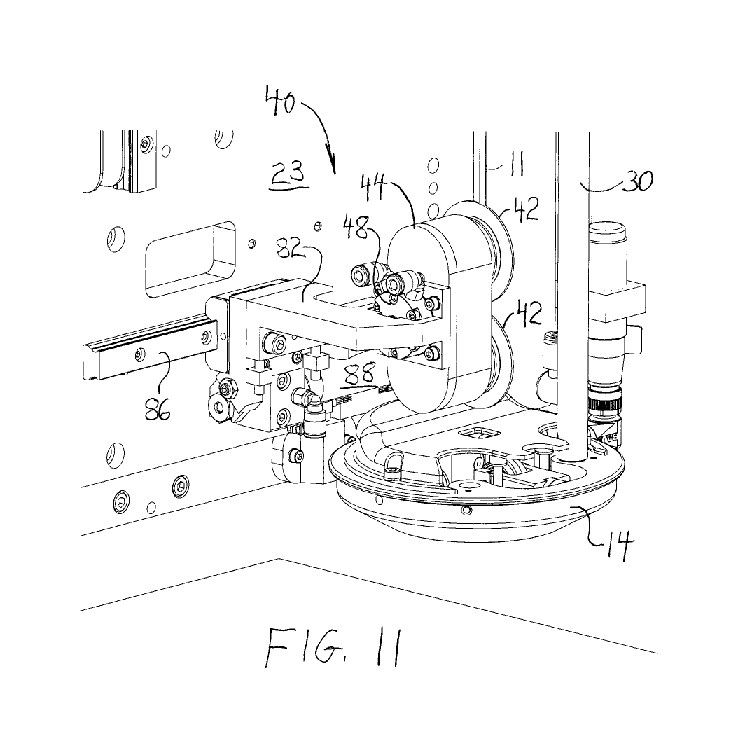

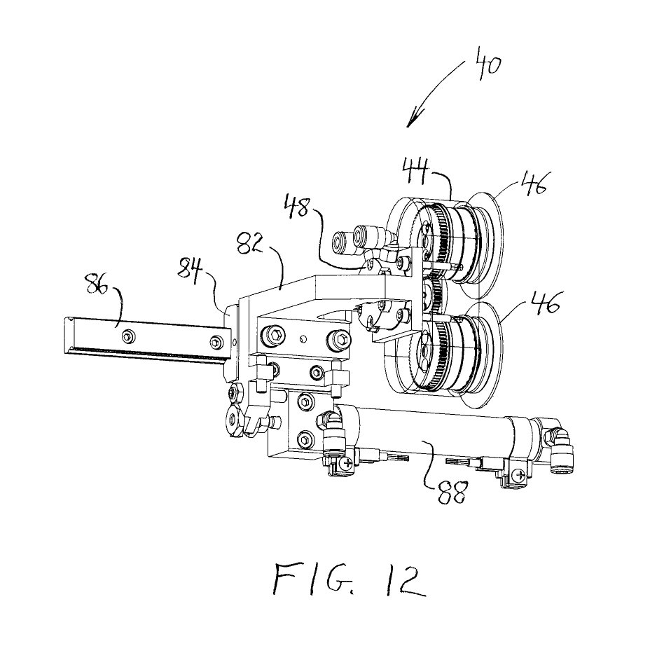

A blade sharpening assembly 40 of the present invention will now be described in greater detail with reference to FIGS. 9-13. FIG. 9 shows sharpening assembly 40 in operating position for sharpening blade 11. Sharpening assembly 40 includes a pair of circular sharpening discs 42 each having a magnetic backing disc coated with an abrasive material for contacting blade 11. During sharpening, the metal blade 11 is urged by magnetic force into flat engagement with sharpening discs, thereby avoiding the problem of blade deflection experienced in sharpening mechanisms of the prior art. An added benefit of magnetic discs 42 is that metal particles removed from blade 11 will adhere to the discs to keep pressure foot 14 free of debris; the metal particles may be removed from discs 42 simply by blotting the abrasive face of discs 42 with adhesive tape.

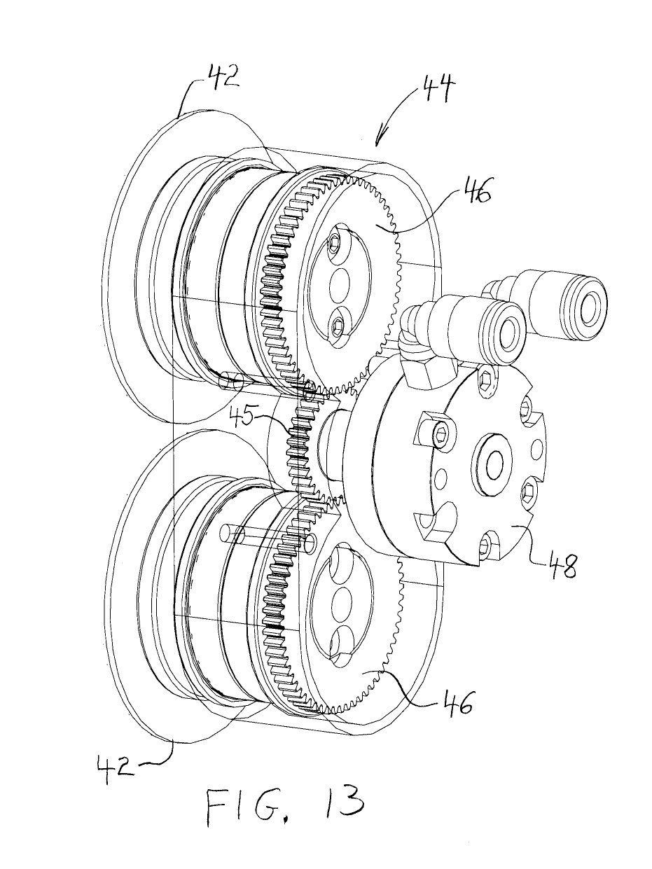

Sharpening discs 42 may be rotatably mounted on an indexing unit 44 enabling the discs to be angularly indexed from time to time to expose an unused portion of the abrasive disc face to blade 11. Indexing unit 44, best shown in FIG. 13, may include a central drive gear 45 mated with a pair of follower gears 46. Drive gear 45 may be driven by a pneumatic rotary actuator 48. The number of degrees in the angular indexing steps may be chosen such that 360° is unevenly divisible by the indexing step in order to present an unused portion of the abrasive surface after each indexing step over multiple complete rotations of discs 42.

Sharpening discs 42, indexing unit 44, and rotary actuator 48 are carried by a forwardly extending support arm 82 mounted on slide plate 23 for laterally directed travel by a linear slide bearing 84 engaging a horizontal rail 86 fixed to a lower portion of slide plate 23. Support arm 82 is movable along rail 86 by operation of a linear actuator 88 having one end fixed to slide plate 23 and another end connected to the support arm. Thus, sharpening discs may be selectively moved into an operating position to engage blade 11, and the knife assembly may reciprocated up-and-down to sharpen the blade edge. The sharpening angle of the blade edge is adjustable by operating motor 22 to rotate pressure foot assembly 28 and the portion of the knife assembly including splined shaft 34, collar assembly 80, and blade 11. Once sharpening is completed, linear actuator 88 is operable to move the sharpening discs 42 and indexing unit 44 out of the way.

Embodiments of the present invention are described in detail herein, however those skilled in the art will realize that modifications may be made. Such modifications do not stray from the spirit and scope of the invention as defined by the appended claims.

What is claimed is:

1. A cutting tool head for cutting sheet materials, the cutting tool head comprising:
a support assembly;
an eccentric mechanism;
a pressure foot having a knife opening;
a knife assembly including a support shaft drivably connected to the eccentric mechanism and a vertical blade connected to the support shaft, wherein the eccentric mechanism drives reciprocating up-and-down motion of the support shaft and the blade, and wherein the blade is extendable through the knife opening of the pressure foot;
wherein the eccentric mechanism, the knife assembly, and the pressure foot are mounted on the support assembly for vertical movement as a unit relative to the support assembly; and
wherein the pressure foot is mounted on the slide plate by way of at least one linear actuator operable to move the pressure foot up and down relative to the eccentric mechanism and the knife assembly.

2. The cutting tool head according to claim 1, wherein the eccentric mechanism, the knife assembly, and the pressure foot are mounted on a slide plate connected to the support assembly by at least one linear slide bearing movable along a corresponding vertical rail fixed to the support assembly, and the cutting tool head comprises a further linear actuator operable to move the slide plate up and down relative to the support assembly.

3. A cutting tool head for cutting sheet materials, the cutting tool head comprising:
a support assembly;
an eccentric mechanism;
a splined bushing;
a knife assembly including a support shaft drivably connected to the eccentric mechanism, a vertical blade connected to the support shaft, and a vertical splined shaft arranged between the support shaft and the vertical blade, the splined shaft being slidably received by the splined bushing,
wherein the eccentric mechanism drives reciprocating up-and-down motion of the support shaft, the splined shaft, and the blade relative to the splined bushing;
wherein the eccentric mechanism, the knife assembly, and the splined bushing are mounted on the support assembly for vertical movement as a unit relative to the support assembly; and
wherein the splined bushing is rotatable about a vertical axis relative to the support shaft, and the splined shaft and the blade rotate with the splined bushing relative to the support shaft.

4. The cutting tool head according to claim 3, wherein the splined shaft is connected to the support shaft by a ball joint.

5. The cutting tool head according to claim 4, wherein no portion of the ball joint is guided by the splined bushing.

6. The cutting tool head according to claim 3, wherein the eccentric mechanism, the knife assembly, and the splined bushing are mounted on a slide plate connected to the support assembly by at least one linear slide bearing movable along a corresponding vertical rail fixed to the support assembly, and the cutting tool head comprises a linear actuator operable to move the slide plate up and down relative to the support assembly.

7. The cutting tool head according to claim 6, further comprising yoke mounted on the slide plate for travel therewith, a rotation sprocket supported by the yoke for rotation about the vertical axis, a support cylinder coupled to the rotation sprocket for rotation therewith, and a drive motor operable to rotate the sprocket and the support cylinder about the vertical axis, wherein the splined bushing is coupled to the support cylinder for rotation therewith.

8. A cutting tool head for cutting sheet materials, the cutting tool head comprising:
an eccentric mechanism;
a knife assembly including a support shaft drivably connected to the eccentric mechanism and a vertical blade connected to the support shaft, wherein the eccentric mechanism drives reciprocating up-and-down motion of the support shaft and the blade; and
at least one blade sharpening disc including a sharpening surface coated with abrasive material for contacting the blade and a magnetic backing disc behind the sharpening surface for magnetically attracting the blade to urge the blade into contact with the sharpening surface.

9. The cutting tool head according to claim 8, further comprising an indexing unit operable to angularly index the at least one blade sharpening disc to expose an unused portion of the abrasive surface to the blade.

10. The cutting tool head according to claim 9, wherein the indexing unit is configured to provide a predetermined angular indexing step, wherein 360° is unevenly divisible by the indexing step in order to expose an unused portion of the abrasive surface to the blade after each indexing step over multiple complete rotations of the at least one blade sharpening disc.

11. The cutting tool head according to claim 9, wherein the at least one blade sharpening disc comprises an upper blade sharpening disc and a lower blade sharpening disc, and the indexing unit includes a pair of follower gears respectively associated the upper and lower blade sharpening discs and a central drive gear mated with the pair of follower gears.

12. The cutting tool head according to claim 9, wherein the at least one blade sharpening disc and the indexing unit are mounted on the cutting tool head by for laterally directed travel toward and away from the blade.
